(19) United States
(12) Patent Application Publication
(10) Pub. No.: US 2024/0166493 A1
(43) Pub. Date: May 23, 2024

(54) GAS FILLING DEVICE

(71) Applicant: Tatsuno Corporation, Tokyo (JP)

(72) Inventors: Rena FUJII, Tokyo (JP); Ko SAITO, Tokyo (JP); Katsumi NAGAI, Tokyo (JP)

(21) Appl. No.: 18/505,450

(22) Filed: Nov. 9, 2023

(30) Foreign Application Priority Data
Nov. 18, 2022 (JP) 2022-184630

(51) Int. Cl. B67D 7/84

(52) U.S. Cl. CPC B67D 7/84; B67D 2210/00031

(57) ABSTRACT

To provide a gas filling device with a drainage treatment for rainwater that splashes onto a display panel side when the display panel is opened or closed for maintenance and inspection. A gas filling device 100 according to the present invention in which a display panel 10 having a filling amount indicator 1 therein is laterally opened, the gas filling device 100 including: an intermediate unit 50 disposed in a housing body 101, the intermediate unit 50 combined with the display panel 10; a sealing mechanism disposed in a portion of the intermediate unit 50 that faces an upper edge of the display panel 10; a rain gutter 12 disposed above the filling amount indicator 1, the rain gutter 12 extending in a width direction of the display panel 10.

### CROSS-REFERENCE TO RELATED APPLICATIONS

The present application claims priority to Japanese Patent Application No. 2022-184630 filed on Nov. 18, 2022, the disclosure of which is incorporated herein by reference.

### STATEMENT RE: FEDERALLY SPONSORED RESEARCH/DEVELOPMENT

Not Applicable

### BACKGROUND

### 1. Field of the Invention

The present invention relates to a gas filling device, in particular, to a gas filling device equipped with a filling amount indicator on a display panel.

### 2. Description of the Related Art

Japan is poor in fossil fuels and dependent on imports from abroad, making it vulnerable to international conditions. Therefore, in recent years, hydrogen, which is environmentally friendly and can be produced from various resources, has attracted attention for its usefulness in energy security. The applicant has also developed, to address this environmental problem, gas filling devices that stably and efficiently fill gas fuel into on-board tanks installed in vehicles such as fuel cell vehicles and hydrogen vehicles that use hydrogen gas as fuel. An indicator of this gas filling device is housed, as shown in JP-A-Heisei06-179499 gazette, in an upper case. At a joint between the upper case and a display panel attached to a front of the upper case, a double packing structure has been provided to prevent rainwater from entering a joint surface of the upper case where it joins an upper edge of the display panel. The double packing is effective in preventing water from entering the display panel. However, when the display panel is opened (e.g., at the moment of opening), rainwater that has accumulated on the upper surface of the upper case may splash onto the back of the display panel. If rainwater splashes onto the back of the display panel, it may stick to the filling amount indicator and cause it to malfunction if such an indicator is on the display panel's side.

The content of JP-A-Heisei06-179499 gazette is incorporated herein by reference in its entirety.

### BRIEF SUMMARY

The present invention has been proposed in view of the above-mentioned problems of the prior art, and the object thereof is to provide a gas filling device with a drainage treatment for rainwater that splashes onto the display panel side when the display panel is opened for maintenance and inspection.

A gas filling device of the present invention is a gas filling device 100 in which a display panel 10 having a filling amount indicator 1 therein is laterally opened, and the gas filling device 100 is characterized by including: an intermediate unit 50 disposed in a housing body 101, the intermediate unit 50 combined with the display panel 10; a sealing mechanism (a packing, for instance) disposed at least in a portion of the intermediate unit 50 that faces an upper edge of the display panel 10; a rain gutter 12 disposed above the filling amount indicator 1 disposed on (a rear face of) the display panel 10, the rain gutter 12 extending in a width direction of the display panel 10. In the present invention, the sealing mechanism is preferably in contact with an upper edge of the display panel 10 at a position that covers an upper part of the rain gutter 12.

In the present invention, a length of the rain gutter 12 is preferably longer than a width of the filling amount indicator 1. In addition, a hole 13 is preferably formed on a lower end of the display panel 10.

According to the gas filling device of the present invention with the above construction, a sealing mechanism such as a packing is disposed at least in a portion of the intermediate unit 50 that faces an upper edge of the display panel 10, and a rain gutter 12 is disposed above the filling amount indicator 1 disposed on the display panel 10, so that when the display panel 10 is opened, even if rainwater accumulated in the sealing mechanism splashes onto the display panel 10, the rain gutter 12 will catch it. Therefore, rainwater is prevented from dripping onto the filling amount indicator 1 located on the display panel 10 (back side of the display panel 10), thereby eliminating any malfunctions or defects of the filling amount indicator 1 due to contact with rainwater. If the sealing mechanism is in contact with the display panel 10 so as to cover the upper part of the rain gutter 12, the sealing mechanism prevents rainwater from entering the back side of the display panel 10 from above the rain gutter 12 when the display panel 10 is closed. Consequently, rainwater will not come into contact with the filling amount indicator 1.

In the present invention, if the rain gutter 12 is formed longer than the width of the filling amount indicator 1, rainwater that drips down when the display panel 10 is open can be drained downward from both ends of the rain gutter 12 to prevent the rainwater from sticking to the filling amount indicator 1. If a hole 13 is formed at the lower end of the display panel 10, rainwater drained from the rain gutter 12 can be discharged outside through the hole 13 when the display panel 10 is open.

### BRIEF DESCRIPTION OF THE DRAWINGS

FIG. 1 is a perspective view showing a gas filling device according to an embodiment of the present invention in which various panels are in an open state.

FIG. 2 is a rear view of a display panel of the gas filling device.

FIG. 3 is a partially enlarged view showing a rain gutter on a rear side of the display panel.

FIG. 4 is a front view of the display panel.

FIG. 5 is an enlarged cross-sectional view taken along a line A4-A4 line in FIG. 4.

FIG. 6 is a perspective view showing the position of a hose release guide in a side unit.

FIG. 7 is a perspective view showing the hose release guide in a closed state.

FIG. 8 is a perspective view showing the hose release guide in an open/closed motion.

FIG. 9 is a front view of the filling device according to the embodiment.

FIG. 10 is a perspective view showing a pressure relief valve used in the embodiment.

FIG. 11 is a partially enlarged view showing sensing and movable portions of a limit switch of the pressure relief valve, showing a state in which the sensing part and the movable part are contact with each other.

FIG. 12 is a partially enlarged view similar to FIG. 11, showing a state in which the sensing part and the movable part are separated.

FIG. 13 is an explanatory view showing an effect of the state in which the sensing section and the movable section are in contact with each other in the previous embodiment.

FIG. 14 is a perspective view showing a spacer used for the limit switch of the pressure relief valve.

FIG. 15 is a perspective view showing a state in which a bracket is mounted on a top of a main body of the pressure relief valve.

FIG. 16 is a perspective view showing another state, different from that shown in FIG. 15, in which a bracket is mounted on a top of a main body of the pressure relief valve.

FIG. 17 is a front view showing a state in which an IR box is accommodated in the intermediate unit in the above-mentioned embodiment.

FIG. 18 is a front view showing a state in which the IR box is pulled out and held from the state shown in FIG. 17.

FIG. 19 is a perspective view of a harness safety joint used in the above embodiment.

FIG. 20 is a vertical cross-sectional view of the harness safety joint shown in FIG. 19.

FIG. 21 is a longitudinal cross-sectional view similar to FIG. 20, showing a state in which the harness safety joint is separated.

### DETAILED DESCRIPTION

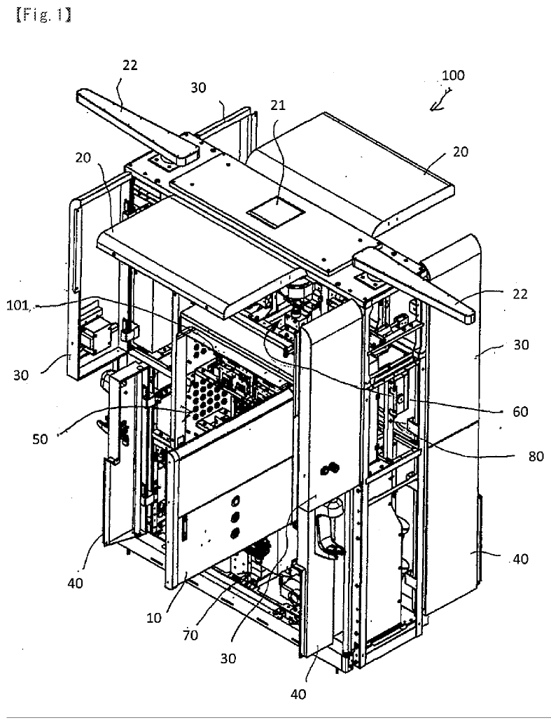

Hereinafter, a gas filling device according to an embodiment of the present invention will be described below with reference to the accompanying drawings. In FIG. 1, the gas filling device 100 is shown, and various panels of the gas filling device 100 are opened. The various panels are a display panel (front panel) 10, a front upper panel 20, a front lower panel (not shown), a front side upper panel 30, and a front side lower panel 40. In FIG. 1, the display panel 10, the front side upper panel 30, and the front side lower panel 40 open and close in a lateral direction, while the front upper panel 20 opens and closes upward. In FIG. 1, a reference numeral 21 indicates an explosion door as a safety device, and a reference numeral 22 indicates a support arm for supporting the operation of a filling nozzle and a filling hose. The gas filling device 100 is composed of an intermediate unit 50, a top unit 60, a bottom unit 70, and side units 80 on both sides, each of which houses equipment necessary for filling hydrogen and other gases. The display panel 10 is attached to the front of the intermediate unit 50. In this gas filling device 100, the side with a counter having a display section and a filling amount indicator on the display panel 10 is the front side. For example, when the filling device is capable of filling a vehicle from both sides, the counters are attached to both sides, and both sides are the front.

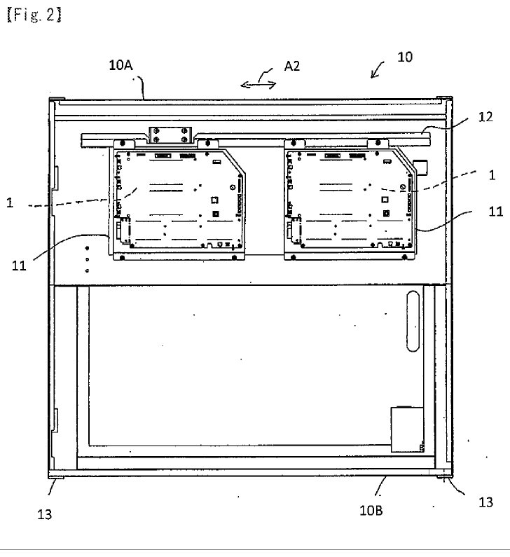

In FIG. 2, which shows the back side (inner surface) of the display panel 10, there are two electronic device mounting sections 11 on an upper portion of the display panel 10 on the left and right, where the filling amount indicator (counter) 1 and necessary electronic devices, etc. are each located. In FIG. 2, the location of the filling amount indicator 1 is not specified, but is indicated only by a broken line and a reference numeral 1. In FIG. 2, a rain gutter 12 is located above the electronic device mounting sections 11 and near an upper edge of the display panel 10. The rain gutter 12 extends horizontally (in a width direction, the arrow A2 direction) and its length are longer than the width of the filling amount indicator 1 (in FIG. 2, the sum of the widths of the two electronic device mounting sections 11 on the left and right).

Since the rain gutter 120 is provided to extend in the width direction above (the filling amount indicator 1 of) the electronic device mounting section 11, water splashed on the back surface of the display panel 10 when the display panel 10 is opened is prevented from contacting with electronic equipment such as the filling amount indicator 1 located in the electronic device mounting section 11. The mechanism involved will be explained with reference to FIG. 2 and others. Although not clearly shown, a sealing mechanism (not shown) is provided all over the portion of the intermediate unit 50 that faces the upper edge 10A of the display panel 10 shown in FIG. 2. The sealing mechanism is in contact with the upper edge 10A of the display panel 10 at a position that covers at least the upper part of the rain gutter 12 when the display panel 10 is closed. When the display panel 10 is closed, the sealing mechanism contacts the upper edge 10A of the display panel 10, and water does not enter from the contact area. Therefore, when the display panel 10 is closed, rainwater or the like is prevented from entering the electronic device mounting section 11 side of the display panel 10.

However, when the display panel 10 is opened (for example, at the moment it is opened), rainwater that has accumulated on the sealing mechanism (not shown) provided in the intermediate unit 50 splashes and spills onto the back surface of the display panel 10. Even in such a case, as shown in FIG. 2, since the rain gutter 12 is arranged above the electronic device mounting sections 11, all the rainwater splashing on the display panel 10 will flow into the rain gutter 12 and does not reach the electronic equipment disposed in the lower electronic equipment mounting part 11. In addition, the water that has entered the rain gutter 12 flows in a longitudinal direction of the rain gutter 12 (the arrow A2 direction in FIG. 2) and falls from both ends (both left and right ends in FIG. 2), which prevents the electronic equipment from coming into contact with water droplets. Therefore, it is possible to eliminate the causes of failures and malfunctions caused by rainwater coming into contact with electronic devices. Through holes 13 are formed in the lower surface 10B (lower end) of the display panel 10 at locations corresponding to the position where water falls from the rain gutter 12, which causes water falling from both ends of the rain gutter 12 to be discharged to outside of the filling device 100 through the through holes 13, and prevents water from remaining inside the filling device 100.

The rain gutter 12 is attached to the display panel 10, and the rain gutter 12 and the display panel 10 are fixed in a watertight manner. For example, they are fixed with adhesive. Spot welding is not used to attach the rain gutter 12 to the display panel 10. This is because if the rain gutter 12 is spot-welded to the sheet metal of the display panel 10, water may leak from the area between the spots, causing water droplets to come into contact with the electronic equipment. In contrast, when adhesive is used to secure the gutter 12, the side of the rain gutter 12 contact the back of the display panel 10 over the entire area, so that the rain gutter 12 and display panel 10 are secured in a watertight manner, water cannot move downward between the rain gutter 12 and display panel 10, and water droplets will not come into contact with electronic devices. The adhesive used to bond the rain gutter 12 to the display panel 10 can be a commercially available structural adhesive for metal bonding (for example, the trade name “Metal Grip” sold by 3M Japan Limited).

Referring to FIG. 3, the mechanism for opening and closing the display panel 10 is described. In FIG. 3, the support bracket 5 protrudes horizontally from the display panel 10 and has a guide hole 5A. Inserting a rod 4 through the guide hole 5A in the support bracket 5 protruding from the display panel 10 allows the rod 4 to be supported in a manner that allows it to move in a vertical direction. The rod 4 extends and is movable in a vertical direction. Moving the rod 4 in a vertical direction and engaging an upper end vicinity and a lower end vicinity of the rod 4 to an engagement potion not shown (e.g., engagement holes) of the housing body 101 (FIG. 1) of the filling device 100 enable the display panel 10 to be maintained in a closed state. The display panel 10 can be made openable from the closed state by disengaging the upper and lower end vicinities of the rod 4 from the aforementioned engagement portions not shown.

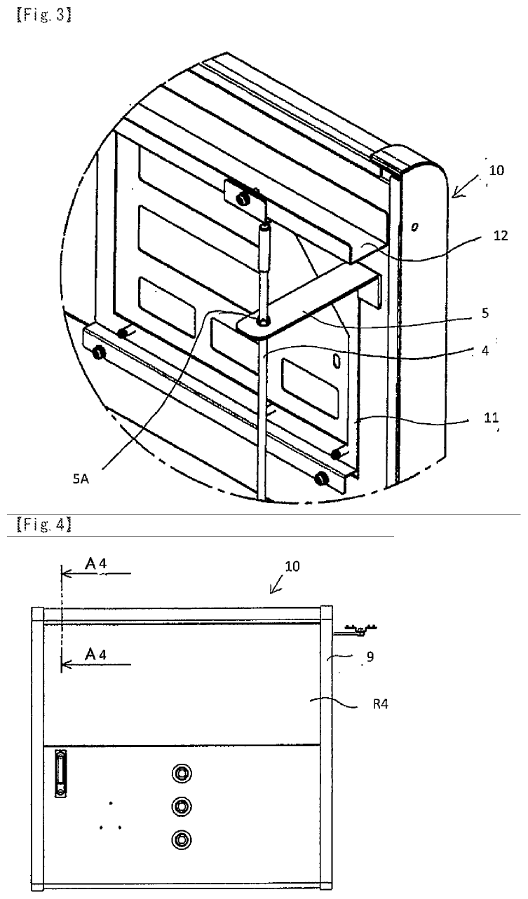

Referring to FIGS. 4 and 5, a structure for attaching the glass 6 to the display panel 10 will be explained. FIG. 4 shows the front surface of the display panel 10 (the surface of the display panel 10: the opposite side of the back surface of the display panel shown in FIGS. 2 and 3). The glass 6 is attached to the portion indicated by a reference symbol R4 in FIG. 4. The glass 6 is attached to the display panel 10 with adhesive GL. In FIG. 4 and FIG. 5, which shows an enlarged A-A line cross section in FIG. 4, the display panel 10 has a panel frame 10-2, and the glass 6 is fixed to the panel frame 10-2 with the adhesive GL. In FIGS. 4 and 5, a reference numeral 9 is a cover. The cover 9 is a resin or sheet metal member that extends vertically at the left and right edges of the display panel 10 (in FIG. 4) and protrudes slightly toward the viewer's side (front side) in FIG. 4. In FIG. 5, the cover 9 is an upper portion painted black. In FIG. 5, in the upper part of the panel frame 10-2, which is a part of the area R4 where the glass 6 is to be fitted, there are two positioning pins 7, shafts of which penetrate through the panel frame 10-2 to determine the position where the glass 6 is to be installed at two points perpendicular to the paper surface. At the bottom of the positioning pins 7 (left end in FIG. 5), there is a flat shaped positioning plate 7A. Pressing the glass 6 with the flat positioning plate 7A causes the glass 6 to be fixed and positioned.

In FIG. 5, the glass 6 is attached to the frame 10-2 of the display panel 10 with the adhesive GL. To ensure proper adhesion, it is necessary to keep a discharge volume of the adhesive GL constant and the position of the glass 6 in a horizontal direction (the arrow A5 direction in FIG. 5) uniform. Therefore, in the embodiment shown in the figure, a spacer 8 with a thickness corresponding to the thickness of the adhesive GL application (dimension in the direction of the arrow A5 in FIG. 5) is placed on the glass 6 side of the panel frame 10-2 as a guide for the amount of the adhesive GL discharged. The adhesive GL used to bond the glass 6 to the display panel 10 is, for example, a “one-component polyurethane-based adhesive” and is commercially available (e.g., trade name “Sika flex” (registered trademark): sold by Sika Japan Ltd.).

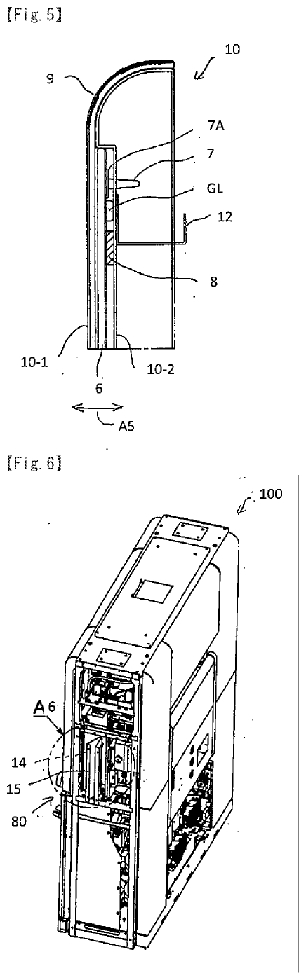

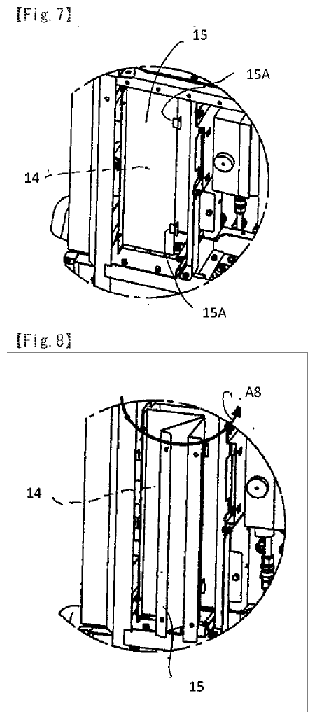

A hose release guide in the illustrated embodiment is described next with reference to FIGS. 6 to 8. In FIG. 6, in an upper part of the side unit 80 of the gas filling device 100, a hose release guide 14 is provided at the location indicated by a reference symbol A6. The hose release guide 14 is provided to guide a filling hose not shown to move to a side where a tensile force was applied when a safety joint not shown is separated due to a tensile force exceeding a predetermined value acting on the filling hose. The hose release guide 14 shown in FIGS. 6 to 8 has a plate member 15 that can be opened and closed. Furthermore, the hose release guide 14 is not clearly shown in FIG. 6, but is indicated only by a dashed pull-out line and a code 14. The plate member 15 is normally closed as shown in FIG. 7, and the interior of the filling device 100 is not exposed. However, when it's removing and installing the safety joint and checking torque, it can be opened as shown in FIG. 8 (an arrow A8) to expose the safety joint built into the filling device 100. As shown in FIG. 7, the plate member 15 is attached to the side unit 80 side (or housing body) with a hinge 15A and can be opened and closed with the hinge 15A. When the plate member 15 of the hose release guide 14 is opened, an internal filling hose, an attachment point, a safety joint, etc. are exposed and visible. Thus, for example, it becomes easier to replace the filling hose, install the plug in the socket of the safety joint, which is done after the safety joint is separated, and perform an accompanying torque check, thereby improving the work efficiency.

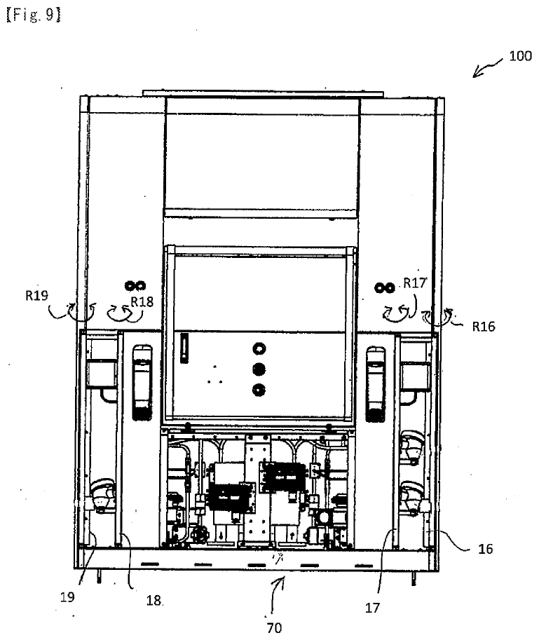

Next, with reference to FIG. 9, a structure for facilitating withdrawal of the filling hose in the illustrated embodiment will be explained. In FIG. 9, which is a front view of the gas filling device 100, filling nozzles not shown are arranged on the left and right sides at storage locations near the left and right ends of the bottom unit 70 at a lower portion of the filling device 100. Pulling out the filling nozzles allows the filling hoses not shown connected to each of the filling nozzles to be pulled out. At that time, if the direction in which the filling hose is pulled out is shifted from the viewer's side (front side) in FIG. 9 to the left or right, the filling hose will come into contact with other members (e.g., members on the housing body side), increasing frictional resistance, and in the worst case, the safety joint will not separate and the filling device 100 will be pulled out. In contrast, in the illustrated embodiment, the right side filling nozzle located near the lower right end of the filling device 100 is positioned between rollers 16 and 17 extending in a vertical direction, with roller 16 configured to rotate freely in the direction of an arrow R16 and the roller 17 configured to rotate freely in the direction of an arrow R17. Therefore, even if the direction in which the filling hose connected to the right-side filling nozzle is pulled out is shifted from the viewer's side (front side) in FIG. 9 to the left or right, the filling hoses contact any of the rollers 16 and 17, so that frictional resistance is reduced by the rotation of the rollers 16 and 17, and the filling hose can be pulled out smoothly without adding tensile force to the filling device 100.

On the other hand, the left side filling nozzle located near a lower left end of the gas filling device 100 in FIG. 9 is positioned between the rollers 18 and 19 extending in a vertical direction, with the roller 18 configured to rotate freely in a direction of an arrow R18 and the roller 19 configured to rotate freely in a direction of an arrow R19. Therefore, the filling hose can be pulled out smoothly in the same manner as the right side filling nozzle described above.

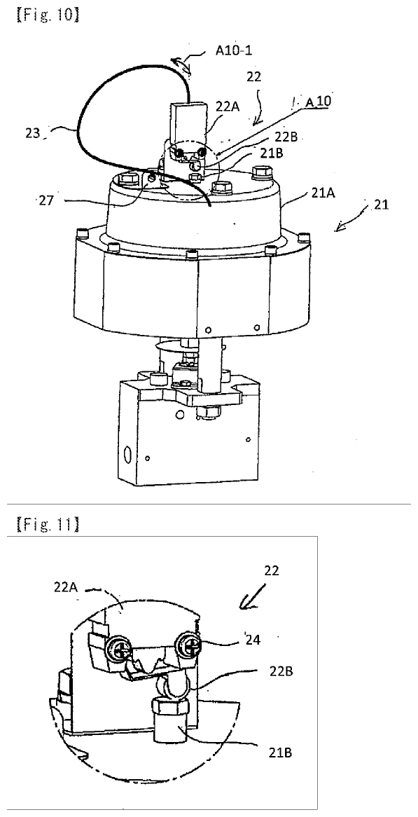

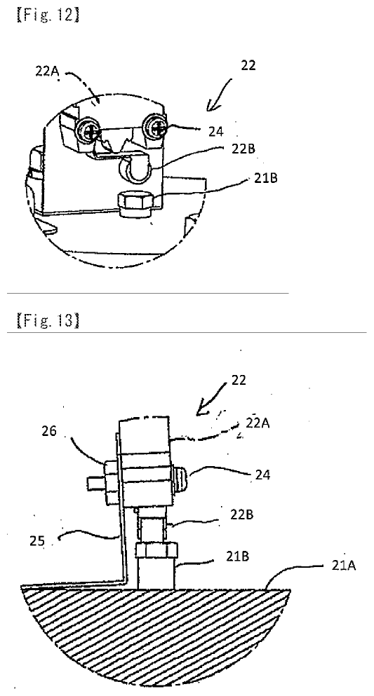

Referring to FIGS. 10 to 14, the pressure relief valve 21 and its switch portion 22 in the illustrated embodiment will be described. FIG. 10 shows the pressure relief valve 21 and its switch portion 22 used in the illustrated embodiment, and the switch portion 22 is disposed at a top of a main body portion 21A of the pressure relief valve 21. The switch portion 22 has a main body portion 22A and a sensing portion 22B, and a cable 23 is connected to the main body portion 22A. As shown in FIG. 11 when the pressure relief valve 21 is activated, the movable portion 21B rises and contacts the sensing portion 22B, and a signal confirming that the pressure relief valve 21 has been activated is output from the main body portion 22A of the switch portion 22 via the cable 23. On the other hand, as shown in FIG. 12, if the movable portion 21B of the pressure relief valve 21 does not rise and the movable portion 21B does not contact the sensing portion 22B, the pressure relief valve 21 does not operate. The switch portion 22 accordingly outputs the operating status of the pressure relief valve 21 as a signal. In FIGS. 11 and 12, a reference numeral 24 indicates a mounting screw for attaching the main body portion 22A to the bracket 25.

In FIG. 10, the cable 23 moves, for example in a direction of an arrow A10-1, and the connected main body portion 22A also swings, which may cause the switch portion 22 to malfunction, or the mounting screw 24 may come loose. On the other hand, in the illustrated embodiment, as shown in FIG. 13, the switch portion 22 is attached to a top of the pressure relief valve body 22A via the bracket 25, which is an elastic L-shaped sheet metal member fastened to the body portion 22A with a fastening member 26. Therefore, even if the movable portion 21B rises above a predetermined amount and presses the sensing portion 22B, bending of the bracket 25 absorbs the excessive rise of the movable portion 21B, causing damages to the switch portion 22 and to the sensing portion, and loosening of the mounting screws 24 to be suppressed or prevented.

Furthermore, fixing the cable 23 to the mounting bracket 27 attached to the top of the main body portion 21A prevents, even if the cable 23 fluctuates violently, malfunction of the switch portion 22 as well as looseness of the mounting screw 24.

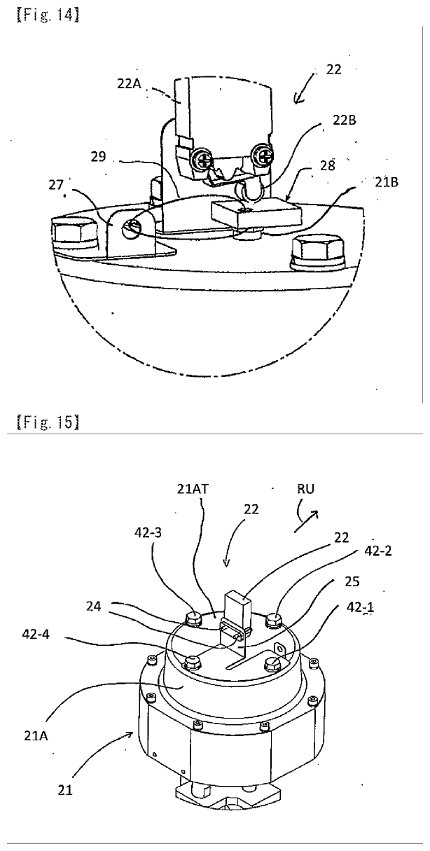

In FIG. 14, for positioning the sensing portion 22B of the switch portion 22, a spacer 28 having a thickness of, for example, 5 mm is attached to the mounting bracket 27 via a flexible member 29 (string, chain, etc.). The thickness of the spacer 28 (for example, 5 mm) is set to be the same as the stroke of the movable portion 21B that moves in a vertical direction. When adjusting the stroke of the movable portion 21B at assembling the switch portion 22, the spacer 28 causes the stroke to be easily adjusted, which facilitates the arrangement and relative positional relationships of various portions. In the illustrated embodiment, the spacer 28 is attached to the mounting bracket 27 via the flexible member 29, so that when the stroke of the movable portion 21B needs to be adjusted, the adjustment can be made immediately using the spacer 28. Therefore, not only during assembly, but also during various maintenance inspections of the gas filling device, the operator can carry out the necessary work without having to carry around the spacer 28 and without having to search for the spacer 28 during work, resulting in improved work efficiency.

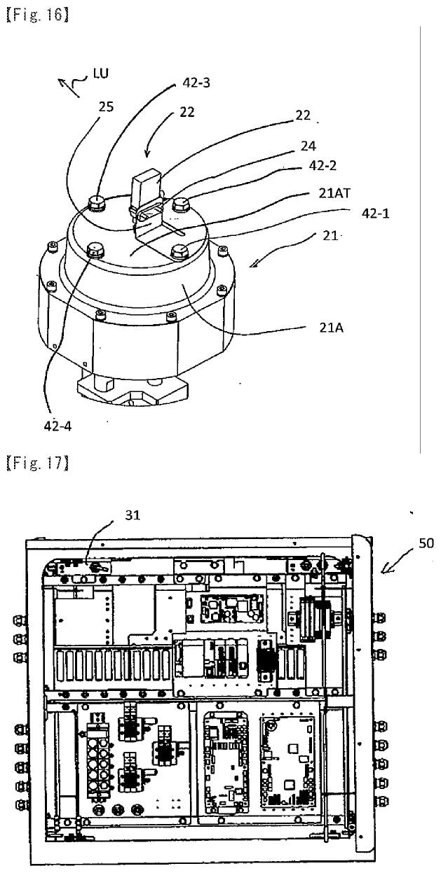

As shown in FIGS. 15 and 16, the bracket 25 is attached to a top 21AT with two bolts 42 at its flat portion (the portion in surface contact with the top 21AT). More precisely, in the embodiment shown in FIG. 15, the flat portion of the bracket 25 is attached to the top 21AT with bolts 42-1 and 42-4, and in the embodiment shown in FIG. 16, the flat portion of the bracket 25 is attached to the top 21AT with bolts 42-1 and 42-2. Here, four bolts 42 (42-1, 42-2, 42-3, 42-4) are provided, and these four bolts 42 are arranged point symmetrically with respect to the center of the top 21AT, and they are arranged at the same pitch in a circumferential direction at an outer edge of the top 21AT.

Arranging the four bolts 42 in a point symmetrical arrangement with respect to the center of the top 21AT at the same pitch in the circumferential direction allows the relative position of the bracket 25 at the top 21AT to be adjusted in the illustrated embodiment, and the orientation of the L-shaped portion in the bracket 25, i.e., the switch portion 22 to be adjusted. For example, in the FIG. 15 configuration, the switch portion 22 is oriented in a direction of an arrow RU (upper right in FIG. 15), whereas in the FIG. 16 configuration, the switch portion 22 is oriented in a direction of an arrow LU (upper left in FIG. 16). Adjusting the orientation of the bracket portion 25 or the switch portion 22 in this way allows a position to be selected where the bracket 25 and the body portion 22 can be easily attached with the mounting screws 24 (or adjusted with the screws 24), reducing the effort involved in such attachment or adjustment work.

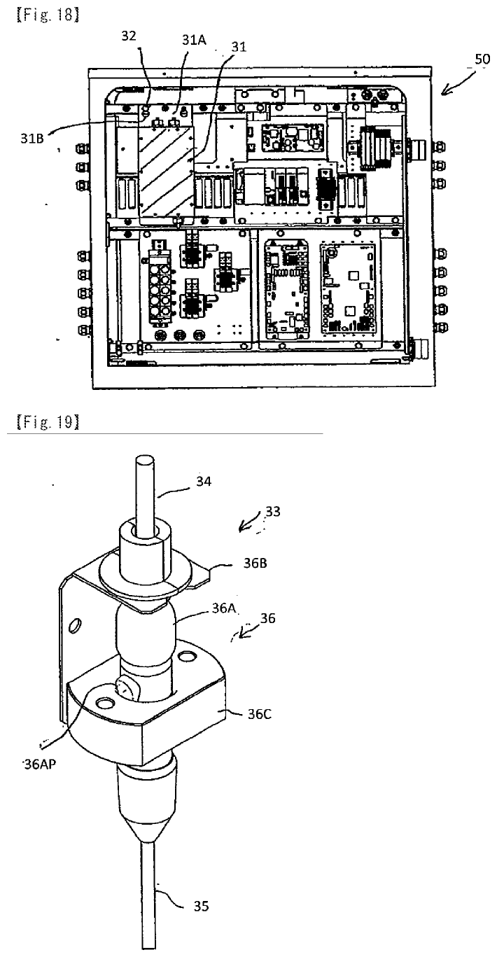

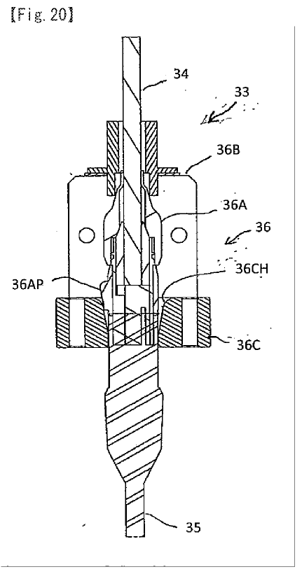

An infrared box (IR box) for communication filling in the gas filling device 100 according to the illustrated embodiment will be described with reference to FIGS. 17 and 18. The IR box is not a device that is handled by workers during normal filling work, but for example, when performing maintenance work such as updating programs or inspecting and connecting cables (for example, wiring work), the box is opened to do the work. The frequency of opening the IR box is low. In the illustrated embodiment, under normal conditions, the IR box 31 is stored in a space above the intermediate unit 50 (see FIG. 1), as shown in FIG. 17. The IR box 31 having a rectangular parallelepiped shape with a predetermined thickness is stored in a space existing at the upper left corner of the intermediate unit 20 so that its longitudinal direction is perpendicular to the plane of the paper in FIG. 17. When performing work with the IR box 31 open (although this is infrequent), such as maintenance work, the IR box 31 is pulled out from the space in the upper left corner of the intermediate unit 20, as shown in FIG. 18, located on the operator's side (front side: viewer's side or front side in FIG. 18). In FIG. 18, a main body of the IR box 31 that has been pulled out is shown with hatching. When the IR box 31 is pulled out, the pin 32 or a bolt protruding from the frame (not shown) in the intermediate unit 50 is inserted into a pothole 31B of the hook 31A to hold the IR box 31 with the hook 31A on the rear edge of the IR box 31 facing upward. Here, the pothole 31B and the pin 32 (or the bolt) are provided at two locations in a horizontal direction in FIGS. 17 and 18. As shown in FIG. 18, if the IR box 31 is pulled out and held so that the work surface of the IR box 31 faces an operator, various operations such as program updates and cable wiring work such as inspection wiring and other maintenance work can be easily performed because the inside of the IR box 31 is exposed to the operator's face.

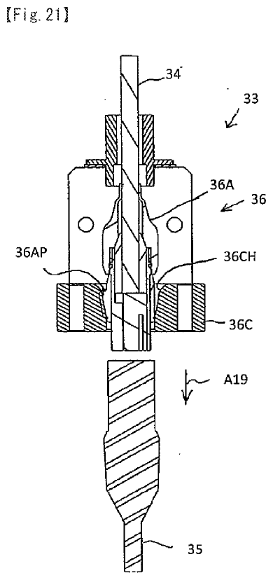

A harness safety joint 33 used in the illustrated embodiment will be explained with reference to FIGS. 19 to 21. The harness safety joint 33 is disposed to transmit signals at communication filling. The harness extends along a filling hose not shown. In FIGS. 19 to 21, the harness safety joint 33 has a harness 34 on the gas filling device (not shown) side, a harness 35 on the vehicle (not shown) side, and a main body 36. The harness 34 on the device side and the harness 35 on the vehicle side are configured to be separable. The main body 36 includes a connecting portion 36A that connects the harness 34 on the gas filling device side and the harness 35 on the vehicle side, a flange portion 36B on the gas filling device side, and a flange portion 36C on the vehicle side. A pressing protrusion 36AP is provided on the connecting portion 36A of the main body 36, and when the pressing protruding portion 36AP is pressed, the harness 35 on the vehicle side and the connecting portion 36A are separated, and the harness 34 on the gas filling device side and the harness 35 on the vehicle side are separated. As shown in FIG. 20, a harness through hole 36CH in the vehicle-side flange portion 36C is formed such that its inner wall shape gradually decreases in inner diameter as it goes downward.

For example, if the safety joint 33 is pulled toward a vehicle, as in the case where a vehicle not shown suddenly starts regardless of the intention of an operator or a driver who is filling the gas, the harnesses 34, 35, and the main body 36 move downward in FIGS. 19 to 21 (in a direction of an arrow A19 in FIG. 21). As described above with reference to FIG. 20, the inner diameter of the harness through hole 36CH in the flange portion 36C decreases smoothly as it goes downward (in the A19 direction), which causes, as shown in FIG. 21, the pressing protrusion 36AP of the connecting portion 36A to be pressed by the inner wall surface of the through hole 36CH of the flange portion 36C. As a result, as shown in FIG. 21, the harness 35 on the vehicle side and the connecting portion 36A are separated to split the harness safety joint 43 into two.

Although not clearly illustrated in the illustrated embodiment, there are no welding points between the units (the intermediate unit 50, the bottom unit 70, and the side units 80 and so on) in the gas filling device 100. Panels that were previously fixed by welding are now attached with adhesive. Here, if the panel is fixed to the unit by welding, the welding marks will be noticeable even after the panel is attached, and it will look bad. Then, when grinding with a sander to remove welding marks, the plating film is also removed, resulting in a decrease in corrosion resistance. On the other hand, in the illustrated embodiment using adhesive, there are no welds, and since the panel is glued to the unit, there are no weld marks, and the appearance is good. In addition to this design effect, the work of grinding away welding marks with a sander becomes unnecessary, the labor required for assembly work is reduced accordingly. Furthermore, since the plating film is not removed by polishing away the welding marks, corrosion resistance does not deteriorate. In addition, since there are no welding points, there are no irregularities, and the sides on which the corresponding panels of each unit are installed are flush with each other, improving the sealing performance of the panel.

It should be noted that the illustrated embodiments are merely examples and are not intended to limit the technical scope of the present invention. For example, although the illustrated embodiments mainly describe a hydrogen gas filling device, the present invention can also be applied to other gaseous fuel filling devices.

### DESCRIPTION OF THE REFERENCE NUMERALS

1 filling amount indicator
10 display panel (front panel)
11 electronic device mounting section
12 rain gutter
13 hole (rainwater discharge hole)
100 gas filling device
101 housing body

1. A gas filling device in which a display panel having a filling amount indicator therein is laterally opened, said gas filling device comprising:
an intermediate unit disposed in a housing body, said intermediate unit combined with the display panel;
a sealing mechanism disposed in a portion of said intermediate unit that faces an upper edge of the display panel;
a rain gutter disposed above the filling amount indicator, said rain gutter extending in a width direction of the display panel.

2. The gas filling device as claimed in claim 1, wherein said sealing mechanism is in contact with the display panel to cover an upper portion of said rain gutter.

3. The gas filling device as claimed in claim 1, wherein a length of said rain gutter is longer than a width of said filling amount indicator.

4. The gas filling device as claimed in claim 3, wherein a hole is formed on a lower end of said display panel.

5. The gas filling device as claimed in claim 2, wherein a length of said rain gutter is longer than a width of said filling amount indicator
